(19) United States
(12) Patent Application Publication
(10) Pub. No.: US 2006/0283484 A1
(43) Pub. Date: Dec. 21, 2006

(54) Method and apparatus for reconditioning tools used to machine sanitaryware and the like

(75) Inventors: Domenico Bambi, Budrio (IT); Daniele Pasotti, Imola (IT)

Correspondence Address: SQUIRE, SANDERS & DEMPSEY L.L.P., 14TH FLOOR, 8000 TOWERS CRESCENT, TYSONS CORNER, VA, 22182, US

(73) Assignee: SACMI COOPERATIVA MECCANICI IMOLA SOCIATÁ COOPERATIVA

(21) Appl. No.: 11/452,286

(22) Filed: Jun. 14, 2006

(30) Foreign Application Priority Data
Jun. 17, 2005 (IT) BO2005A000409

(51) Int. Cl. B08B 1/02; B08B 3/12

(52) U.S. Cl. 134/32; 134/172

(57) ABSTRACT

Described is a method for reconditioning a tool (1) made of porous material or sponge used to machine sanitaryware (2) or the like, especially ceramic sanitaryware (2), that undergoes finishing processes in a working area (3) of a production plant (4) equipped with a robotic unit (5) for processing the sanitaryware (2). The method comprises at least the following steps: moving the sponge (1), which has the shape of a solid of revolution, from the working area (3) to a non-working sponge (1) reconditioning area (6); rotating the sponge (1) about its axis (Z) using related drive means (7); spraying a cleaning/rinsing liquid on the sponge (1); and squeezing the sponge (1) using rotatable pressure means (8) simultaneously along a plurality of lines substantially transversal to the axis (Z) of the sponge (1) and spaced from each other. The invention also relates to an apparatus that implements this method.

### BACKGROUND OF THE INVENTION

This invention relates to a method and an apparatus for reconditioning tools used in the machining of sanitaryware and the like, especially ceramic sanitaryware.

As is well known, ceramic sanitaryware (such as washbasins, toilet bowls, bidets and the like) is made by casting a fluid mixture (known as “slip” in the jargon of the trade, consisting of a ceramic body in aqueous suspension) in customary “shell” moulds with a porous structure.

The mould gives the article of sanitaryware the required shape and after a certain length of time (necessary to draw out the water) the article is extracted from the mould in a solid form, known as “greenware” (still having a water content of between 17% and 20% by weight) and hence still subject to plastic deformation.

Contact of the sanitaryware article with the air brings about two main changes in the article, the first bringing it to an intermediate “leatherhard” state (in which the water content is approximately halved in weight compared to the previous state) and the second, to an almost finished “whitehard” state (in which the water content is practically zero): in these two states, the sanitaryware article is no longer subject to plastic deformation.

In one or more of these three different states, the sanitaryware article undergoes a plurality of finishing processes such as, for example, deburring, drilling of holes, slotting, radiusing and so on.

For a long time, these processes were performed manually at special stations in the production plants but in recent years have been automated to a greater and greater extent (not only for safety reasons but also to increase productivity): in practice, operating islands equipped with auxiliary units for performing these processes have been created.

These units drive the cutting, grinding and other tools, both rigid and deformable, used to finish the sanitaryware articles as they arrive at the operating island.

Advances in technology have led to the development of increasingly precise machines and tool drive systems which have transformed into reality the possibility of applying certain finishing processes to sanitaryware that is still in the “greenware” state (of particular interest in this text) which, owing to its composition, has disadvantages but also some advantages:

one disadvantage is the high risk of plastic deformation of the sanitaryware which means processing requires very high precision and a high level of attention and which may therefore be quite slow;

a significant advantage, on the other hand, is the fact that an excellent finish at this stage avoids certain processes at later stages when the ceramic body is harder and thus, when machined, produces more dust and is subject to a higher risk of breaking.

Since greenware still has a relatively high water content, the finishing processes applied to it at this stage involve material removal or surface smoothing.

One of the tools used for these processes, of deformable type, consists of a porous, usually sponge-like element.

This tool, when used with an automated finishing unit, preferably has the shape of a solid of revolution (cylinder, barrel, etc.) and may be mounted on an arm equipped with a drive motor that causes the sponge to revolve about its axis.

The contact between the revolving sponge and the surface of the sanitaryware at predetermined speed and pressure abrades (and hence removes material from) the surface of the sanitaryware and redistributes the excess material, thus finishing the surface.

As already stated, the sanitaryware in this state still has a relatively high water content and the sponge, as it works, absorbs a part of this water, mixed with the clayey material removed from the surface of the sanitaryware, thus becoming thick and sticky.

To keep the sponge in optimum working conditions so that it can impart a good surface finish to the sanitaryware at all times, the sponge must be reconditioned or cleaned at regular intervals, depending on the type of sponge and the process it is being used for (rough grinding or finishing).

The reconditioning cycles may be very frequent, so that the sponge is cleaned between each sanitaryware article and the next, or less frequent, so that it is cleaned after a predetermined number of sanitaryware articles machined. At present, reconditioning basically comprises a step of wringing out the sponge (by applying pressure to it).

This step may consist, for example, of wringing out the sponge by repeatedly moving it backwards and forwards over a rigid permeable surface (such as perforated metal sheeting) which, however does not effectively remove all the material clinging to it, with obvious negative consequences on the next sanitaryware that is machined.

Reconditioning is thus a critical step essential to obtain sanitaryware with a high-quality finish at all times and the Applicant has therefore devised and developed a method and an apparatus implementing the method with which it is possible to recondition the sponge tool in a quick and sure manner without slowing down the process times of the working station and guaranteeing that the sponge is effectively cleaned.

### SUMMARY OF THE INVENTION

In accordance with the invention, this is achieved by a method for reconditioning a tool made of porous material or sponge used to machine sanitaryware or the like, especially ceramic sanitaryware, that undergoes finishing processes in a working zone of a production plant equipped with a robotic unit for processing the sanitaryware, the method comprising at least the following steps: moving the sponge, which has the shape of a solid of revolution, from the working area to a non-working sponge reconditioning area; rotating the sponge about its axis using related drive means; spraying a cleaning/rinsing liquid on the sponge; and squeezing the sponge using rotatable pressure means simultaneously along a plurality of lines substantially transversal to the axis of the sponge and spaced from each other; the invention also relates to an apparatus that implements this method.

### BRIEF DESCRIPTION OF THE DRAWINGS

The technical characteristics of the invention, with reference to the above aims, are clearly described in the claims below and its advantages are apparent from the detailed description which follows, with reference to the accompanying drawings which illustrate a preferred embodiment of the invention provided merely by way of example without restricting the scope of the inventive concept, and in which:

FIG. 1 is a schematic top plan view, with some parts cut away in order to better illustrate others, of a sanitaryware finishing plant equipped with an apparatus according to the invention for reconditioning a tool used to machine sanitaryware or the like;

FIG. 2 is a scaled-up schematic view, with some parts cut away in order to better illustrate others, of the apparatus of FIG. 1 for reconditioning a tool used to machine sanitaryware;

FIG. 3 is a schematic front view of the apparatus of FIG. 2;

FIG. 4 is a front view, with some parts in cross section, of a pair of squeezing rollers forming part of the apparatus illustrated in the figures listed above;

FIGS. 5 to 10 are top plan views schematically illustrating a sequence of steps constituting the method according to the invention for reconditioning the finishing tool;

FIG. 11 is a hydro-pneumatic diagram of the apparatus illustrated in the figures listed above;

FIG. 12 is a schematic partial front view showing another embodiment of the means for pressing and moving the sponge;

FIG. 13 is a schematic partial front view showing another embodiment of the rollers for pressing the sponge;

FIG. 14 is a side view, with some parts in cross section and others cut away, of the sponge movement means forming part of the apparatus illustrated in the figures listed above;

FIG. 15 is a schematic front view, with some parts cut away in order to better illustrate others, showing an arm of a robotic unit for positioning and moving the sponge according to the method represented in the figures listed above.

### DESCRIPTION OF THE PREFERRED EMBODIMENTS

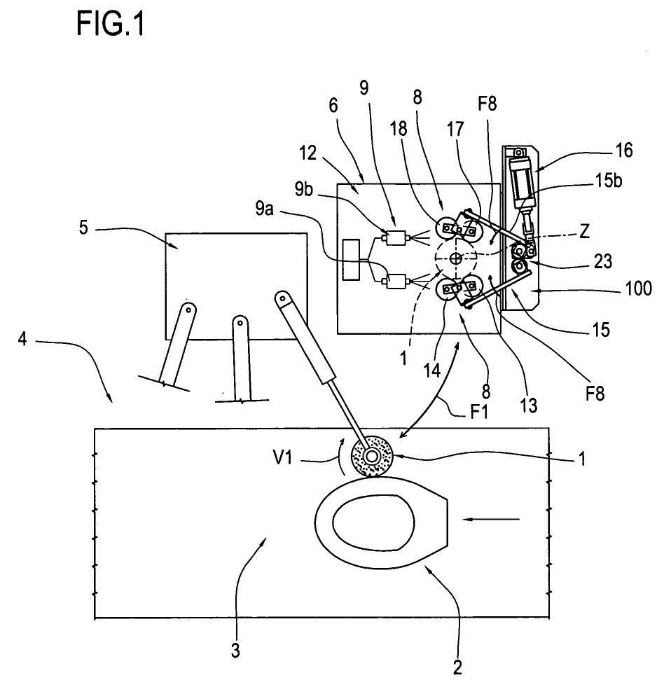

With reference to the accompanying drawings, in particular FIG. 1, the method and apparatus according to the invention are used for reconditioning a tool 1 made of porous material or sponge used to machine sanitaryware 2 or the like.

More specifically, the sanitaryware 2 is made of ceramic and consist, for example, of washbasins, toilet bowls, bidets, etc.

Each of these articles of sanitaryware 2 undergoes finishing processes after being extracted from the mould in a working area 3 of a production plant 4 equipped with a unit 5 for machining the sanitaryware 2.

As described in more detail below, the unit 5 may be of the “manual” type, that is to say, power driven but controlled by an operator, or of the robotic type, that is to say, capable of moving and driving the tools fully automatically, without thereby restricting the scope of the invention.

In this specification, the sponge-tool 1 cleaned in accordance with the invention is preferably used on the sanitaryware 2 in the “green” state, when it is still plastically deformable and from which a considerable amount of material is removed and clings to the porous structure of the sponge 1. This, however, does not limit the use of the method and apparatus on sanitaryware 2 in other states of finish.

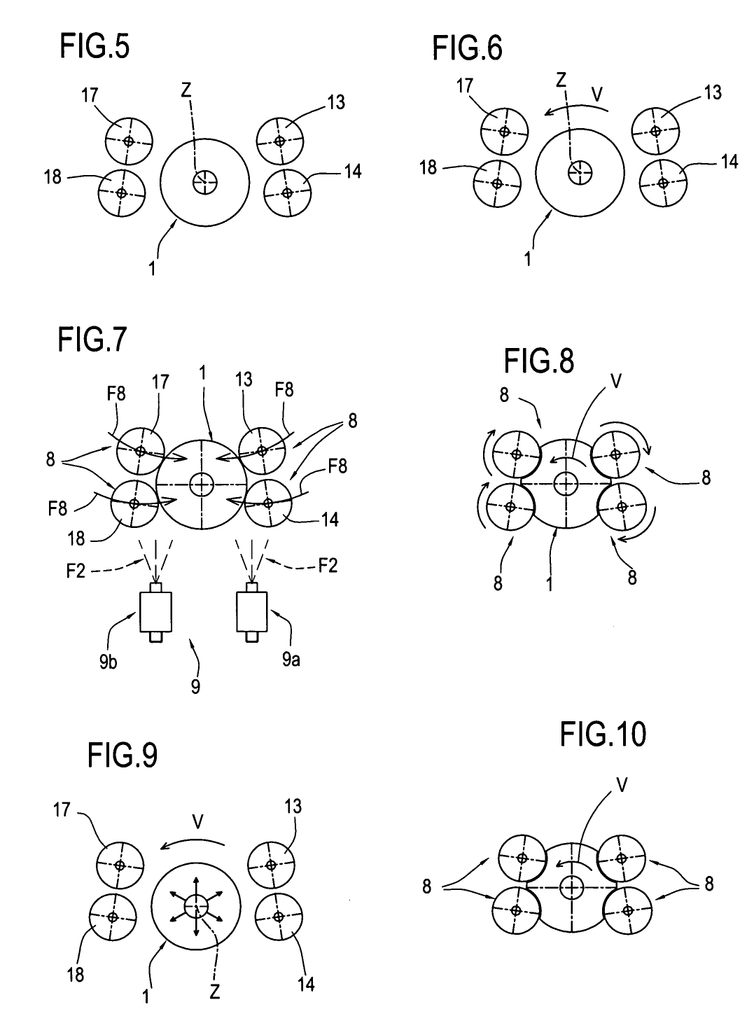

As illustrated in FIG. 1 and in FIGS. 5 to 10, the method according to the invention comprises the following steps:

moving the sponge 1, which has the shape of a solid of revolution, from the working area 3 to a non-working sponge 1 reconditioning area 6 (see FIG. 1 and arrow F1 and FIG. 5);

rotating the sponge 1 about its axis Z using related drive means 7 (see FIG. 6 and arrow V);

spraying a cleaning/rinsing liquid on the sponge 1 (see FIG. 7 and arrow F2); and

squeezing the sponge 1 using rotatable pressure means 8 simultaneously along a plurality of lines substantially transversal to the axis Z of the sponge 1 and spaced from each other (see FIGS. 7 and 8 and arrows F8).

In the embodiment illustrated, the sponge 1 may be cylindrical or barrel shaped, although it will be understood that sponges 1 with the shape of any other solid of revolution are also contemplated by the invention.

The above mentioned squeezing step may also occur simultaneously along a plurality of lines radial to the sponge 1 spaced or equidistant from each other.

As shown in FIGS. 5 to 10, the above mentioned step of rotating the sponge 1 may comprise a rotation of the sponge 1 in a direction V opposite the direction V1 in which it rotates when it machines the sanitaryware 2 (see also FIG. 1).

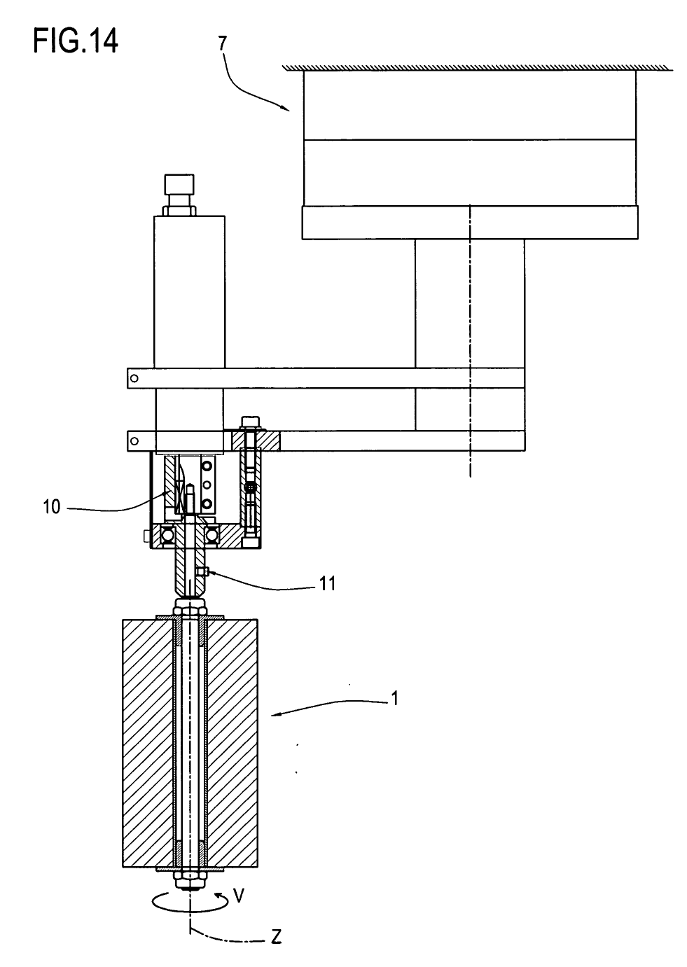

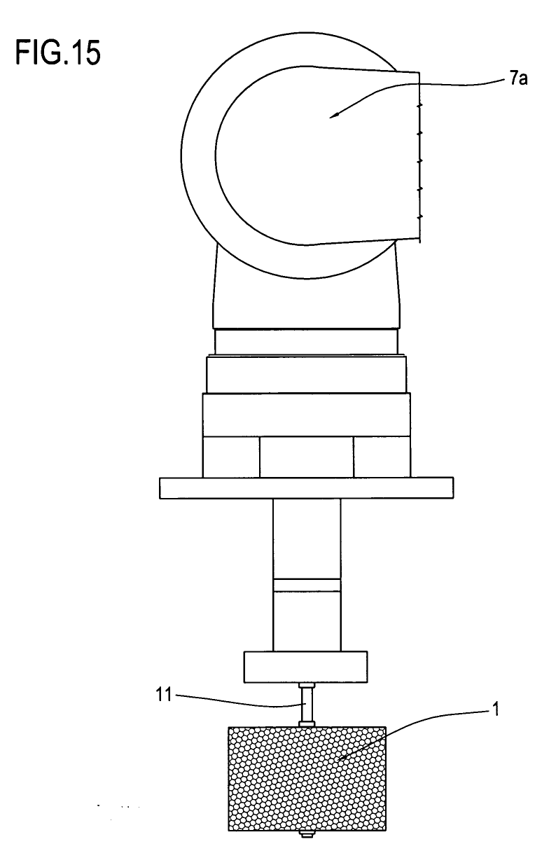

The sponge 1 may be rotated by independent drive means 7 located in the above mentioned non-working area 6 (see FIG. 14).

Alternatively, it may be rotated directly by the drive means 7a mounted on the unit 5 itself, whether the latter is an auxiliary unit controlled by an operator or a robotic unit as mentioned above.

In terms of timing of the steps, the invention may contemplate that the step of rotating the sponge 1 is performed simultaneously with the step of spraying the liquid on the sponge 1 or that the step of rotating the sponge 1 starts before the liquid spraying step.

Alternatively again, the step of rotating the sponge 1 might be stopped during the liquid spraying step and resumed when the latter has been completed.

Similarly, the step of squeezing the sponge 1 might be started at the same time as the step of spraying the liquid or (preferably) the step of squeezing the sponge 1 starts after the step of spraying the liquid.

Preferably, however, the sponge 1 starts rotating at the beginning of the reconditioning cycle and continues rotating throughout the cycle.

To restore the sponge 1 to an optimum, clean condition the spraying and squeezing steps may be cyclically repeated two or more times according to how dirty the sponge 1 is.

In this case (see FIGS. 9 and 10), between one sponge 1 squeezing step and another, there may be another step of rotating the sponge 1 freely for a certain time at a predetermined speed so as to expel the excess liquid from the sponge 1 by centrifugal force.

Since the sponge 1 may be rotated continuously, as stated above, an immediate cleaning effect might be obtained by rotating the sponge 1 at variable speeds according to the spraying and squeezing steps (for example, faster when it is being squeezed and more slowly when liquid is being sprayed onto it).

The squeezing step in which the sponge 1 is pressed by the means 8 might also be performed by applying gradually increasing pressure on the sponge 1 or by applying a constant, instantaneous pressure on the sponge 1.

The method described above may be implemented by an apparatus, denoted in its entirety by the numeral 100, forming part of a production plant 4 having a working area 3 (for example a conveyor belt) equipped with the above mentioned unit 5 for machining the sanitaryware 2.

In order to clean the sponge 1, the apparatus 100 may essentially comprise (see FIGS. 1 to 4 and FIG. 11):

a non-working sponge 1 reconditioning area 6 located in the vicinity of the above mentioned working area 3;

means 7 for rotationally driving the sponge 1 about its axis Z of principal extension;

means 9 for spraying a cleaning or rinsing liquid on the sponge 1;

pressure means 8 acting on the sponge 1, rotatable about their axis, and movable relative to the sponge 1, towards and away from the sponge 1 along lines substantially transversal to the axis Z in such a way as to squeeze and thus clean the sponge 1.

In the order shown above, the reconditioning area 6 may comprise an operating island separate from the working area 3 and consisting of a sealed cabin 12 (see FIG. 1).

The sealed cabin 12 may house drive means 7 (where these are independent) , spraying means 9 and pressure means 8.

As stated, the drive means 7 may be independent and located inside the reconditioning area 6.

As illustrated in FIG. 14, the drive means 7 may comprise a power-driven shaft 10, for example pneumatic, and kinematically connected to a respective support 11 of the sponge 1 in such a way as to rotationally drive the sponge 1 in a direction of rotation V.

In a first alternative (see FIG. 12) the drive means 7m are mounted on the same frame that mounts the pressure means 8.

Another alternative is the one mentioned above, where the means 7a for driving the sponge 1 are those of the unit 5 which is designed to be positioned inside the reconditioning area 6 and to subsequently rotate the sponge 1 in the direction of rotation V.

In all the embodiments, the means 7, 7a for driving the sponge 1 may rotate the sponge 1 in a direction V that may be opposite to the working direction V1 in which the sponge 1 itself rotates when machining.

The spraying means 9 may comprise at least one adjustable nozzle 9a, although there are preferably two nozzles (9a and 9b), connected to a source for supplying the liquid, which may be water under pressure.

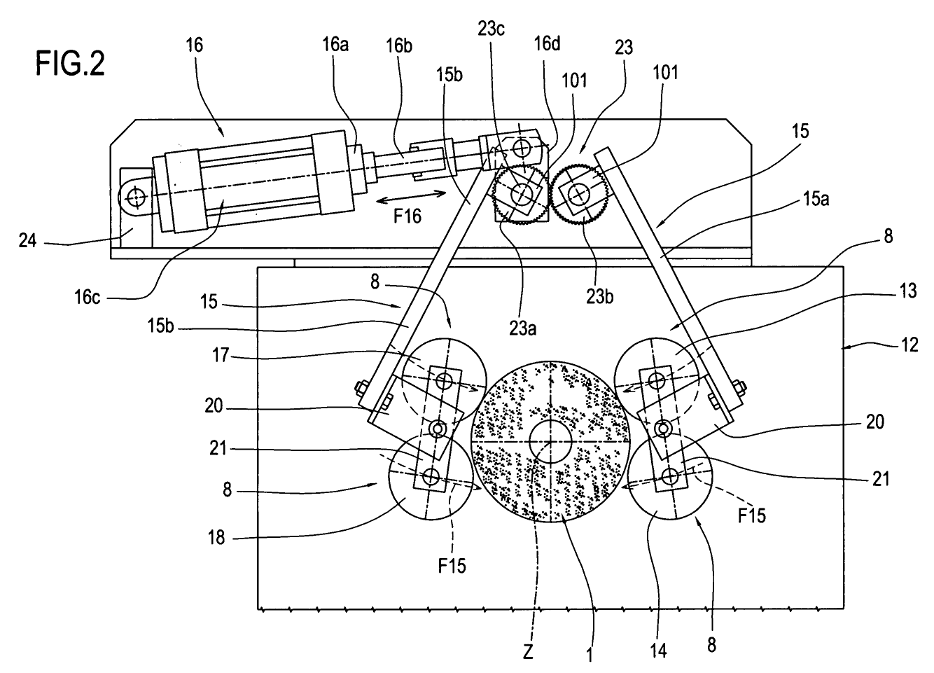

As illustrated in FIGS. 2, 3 and 4, the pressure means 8 may comprise at least one pair 13, 14, but preferably two pairs 13, 14; 17, 18 of cylindrical rollers, each having a vertical axis Z1 and being rotatable about said vertical axis Z1.

These two pairs of rollers 13, 14; 17, 18 are mounted on a frame 15 designed to position each pair of rollers 13, 14; 17, 18 on opposite sides of the sponge 1 in use.

The frame is in turn equipped with drive means 16 acting on the rollers 13, 14; 17, 18 in such a way as to move them from a position in which they are away from the sponge 1 (see FIGS. 5 and 6) to a position in which they are close to and squeeze the sponge 1 along the aforementioned lines transversal or perpendicular to the axis Z of the sponge 1 (see FIGS. 2, 7 and 8 and arrows F8).

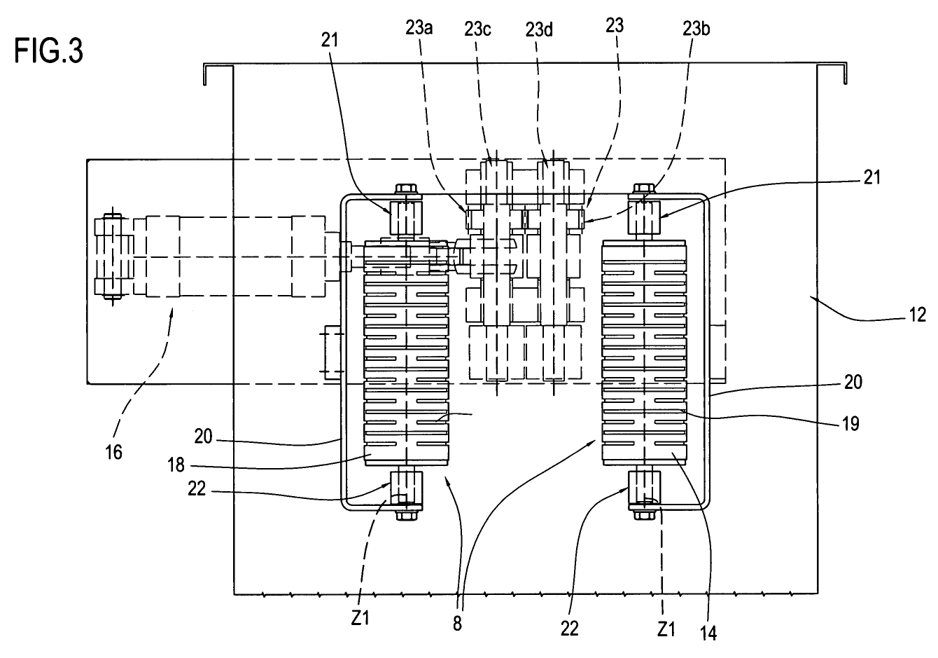

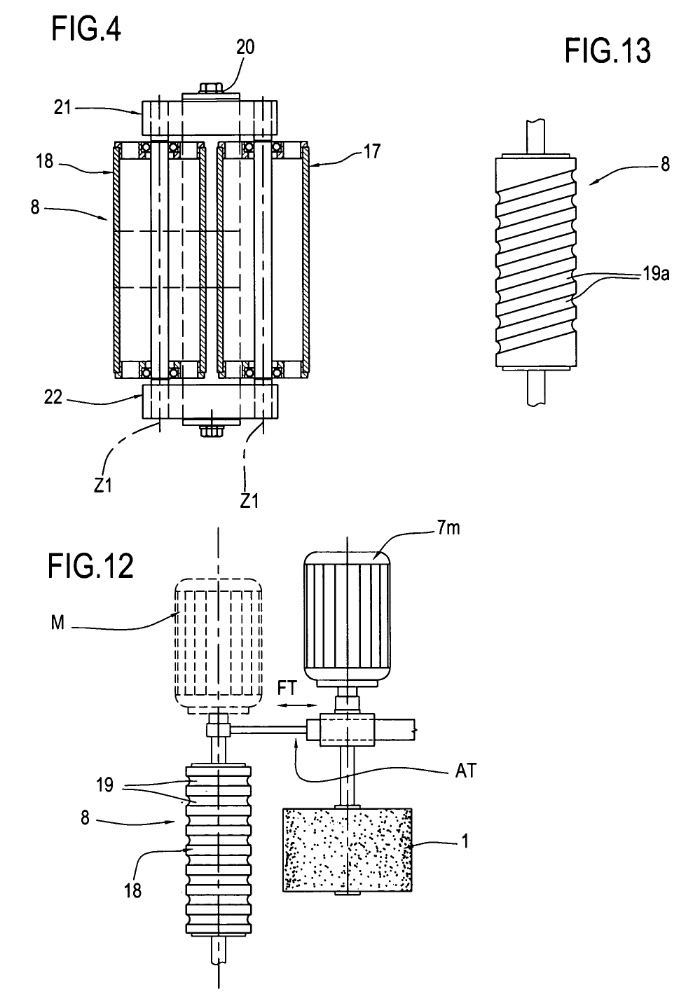

As shown in FIGS. 3 and 4, each roller 13, 14; 17, 18 is preferably but not necessarily rotatable idly about its vertical axis Z1.

FIG. 12, on the other hand, shows another embodiment, by way of example, where each roller 13, 14; 17, 18 has an independent drive motor M enabling it to rotate about its axis Z1. This embodiment may be further varied by using one motor for each pair of rollers 13, 14; 17, 18.

As clearly visible in FIGS. 3 and 12, each roller 13, 14; 17, 18 may have, around its circumference, a plurality of grooves 19 adapted to enable the liquid from the sponge 1 to be drained off (preferably downwards) when the roller 13, 14; 17, 18 itself is close to and squeezes the sponge 1.

Looking more closely at the constructional details, each roller 13, 14; 17, 18 may have a plurality of parallel circumferential grooves 19 located one after the other.

Alternatively, (see FIG. 13) each roller 13, 14; 17, 18 may have a single continuous circumferential groove 19a extending along each roller 13, 14; 17, 18 to form a spiral around the roller 13, 14; 17, 18 itself.

In FIGS. 1 to 3 and 11, the drive means 16 are connected to the frame 15 and act on the rollers 13, 14; 17, 18 in such a way as to vary the pressure of contact with the sponge 1.

FIG. 12, on the other hand, shows an embodiment in which the drive means 16 are independent of each other (for example single actuators AT for each roller) in such a way that each of the rollers 13, 14; 17, 18 can exert a different pressure on the sponge 1 along the above mentioned lines transversal or radial to the sponge 1 (see arrow FT).

Returning to the embodiment illustrated in FIGS. 1 to 4, the above mentioned frame 15 comprises two independent arms 15a and 15b, each mounting at a first end of it a C-plate 20 associated with the respective arm 15a, 15b.

Keyed to each plate 20 in freely rotatable manner there are two bars, 21 and 22, respectively upper and lower, for bilaterally supporting the respective pair of freely rotatable rollers 13, 14; 17, 18 placed side by side: this particular configuration enables each pair of rollers 13, 14; 17, 18 to adapt to the contact with the outer surface of the sponge 1 when the rollers 13, 14; 17, 18 move close to and squeeze the sponge 1.

Each of the arms 15a and 15b is kinematically linked at its other end to transmission means 23 controlled by the above mentioned drive means 16 in such a way that the rollers 13, 14; 17, 18 move towards and squeeze the sponge 1 and then move away from the sponge 1.

More specifically, (see FIGS. 2 and 3), these transmission means 23 comprise a pair of meshing toothed wheels 23a, 23b. The shaft 23c, 23d on which each wheel 23a, 23b rotates is associated with a respective mounting arm 15a, 15b (for example, is keyed to a connecting plate 101) in such way that the drive means 16 can move it along arc-shaped lines (see arrows F15 in FIG. 2), in a horizontal plane, opposite each other so as to cause the two pairs of rollers 13, 14; 17, 18 to simultaneously move towards and squeeze the sponge 1 and then move away from it.

As regards the drive means 16, these may comprise an actuator 16a keyed by its stem 16b to a plate 16d attached to one of the toothed wheels, namely the drive wheel 23a, and at the opposite end, that is, on the cylinder 16c of the actuator 16a, to a fixed support 24 in such a way that, as the stem 16b moves backwards and forwards (see arrows F16, FIG. 2), the toothed wheels 23a, 23b can rotate and thus move the arms 15a, 15b.

To optimize the sponge 1 cleaning method, the actuator 16a may be controlled by a programmable control unit 30 that controls the pairs of rollers 13, 14; 17, 18 in such a way as to perform a single routine or a sequence of automatic cycles in which the pairs of rollers 13, 14; 17, 18 move towards and squeeze the sponge 1 and then move away from it.

Thanks to this unit 30, the actuator 16a may be programmed and controlled in such a way that the pairs of rollers 13, 14; 17, 18 perform at least:

a sequence of automatic cycles in which the pairs of rollers 13, 14; 17, 18 perform a forward squeezing movement and then a return movement; and where the pairs of rollers 13, 14; 17, 18 exert a variable pressure on the sponge 1 as they move towards and squeeze it.

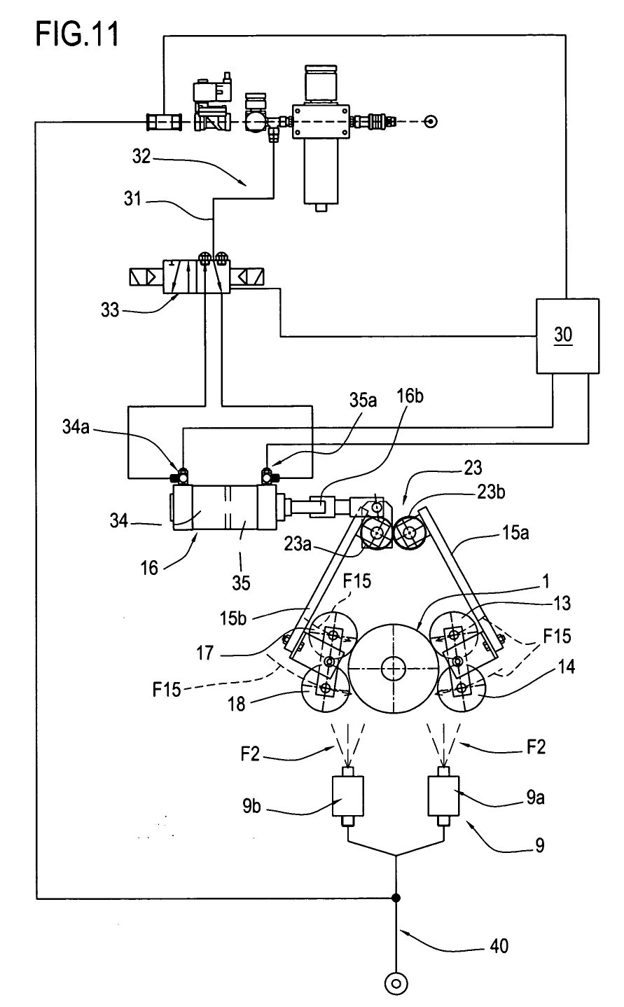

To obtain an operating sequence of this kind (see FIG. 11 again) the actuator 16a, which may, for example, be of the pneumatic double-acting type, is controlled by the programmable control unit 30 through connection of the unit 30 itself to a duct 31 forming part of a circuit 32 for supplying a fluid (air) to the actuator 16a.

The unit 30 may act directly on shutoff means 33 (customary valves) located on the duct 31 and designed to alternately feed the fluid to the chambers 34 and 35 of the actuator 16a, in such a way as to select the movement of the actuator 16a corresponding to the movement of the pairs of rollers 13, 14; 17, 18 towards or away from the sponge 1.

Besides this, the programmable control unit 30 may be connected to and act upon a pair of fluid flow regulators 34a, 35a located at the intake end of the chambers 34, 35 of the actuator 16a in order to vary the pressure exerted on the sponge 1 by the pairs of rollers 13, 14; 17, 18.

Advantageously, (see FIG. 11 again), the air supply circuit 32 may be connected to a circuit 40 that supplies liquid to the nozzles 9a so as to provide an airflow that increases the force of the liquid spray.

The method and apparatus described above achieve the above mentioned aims thanks to a rational and practical structure with which it is possible to clean and recondition the sponge quickly, surely and effectively without interfering with production operations and, in fact, speeding up a step that constitutes a critical aspect of the subsequent sanitaryware finishing process.

Both the method and the apparatus are extremely versatile in terms of structure and do not require significant alterations to existing plant and machinery.

The apparatus can thus be used in conjunction with any type of plant, whether still at the design stage or already constructed, and above all, irrespective of whether the finishing unit is a simple operator-controlled unit or a fully automated robotic unit.

In both cases, the reconditioning apparatus can be used without problems and, in fact, can be effectively integrated in these units, using the existing drive motors of the finishing unit, for example, to recondition the sponge in “masked” time, that is to say, while the unit is performing a different operation on the sanitaryware.

It will be understood that the invention described may be useful in many industrial applications and may be modified and adapted in several ways without thereby departing from the scope of the inventive concept. Moreover, all the details of the invention may be substituted by technically equivalent elements.

1. A method for reconditioning a tool (1) made of porous material or sponge used to machine sanitaryware (2) or the like, especially ceramic sanitaryware (2), that undergoes finishing processes in a working area (3) of a production plant (4) equipped with a unit (5) for processing the sanitaryware (2), the method comprising the following steps:
moving the sponge (1), which has the shape of a solid of revolution, from the working area (3) to a non-working sponge (1) reconditioning area (6);
rotating the sponge (1) about its axis (Z) using related drive means (7);
spraying a cleaning/rinsing liquid on the sponge (1); and
squeezing the sponge (1) using rotatable pressure means (8) simultaneously along a plurality of lines substantially transversal to the axis (Z) of the sponge (1) and spaced from each other.

2. The method according to claim 1, wherein the sponge (1) is cylindrical in shape.

3. The method according to claim 1, wherein the sponge (1) is barrel shaped.

4. The method according to claim 1, wherein the squeezing step is performed simultaneously along a plurality lines radial to the sponge (1) and equidistant from each other.

5. The method according to claim 1, wherein the step of rotating the sponge (1) comprises a rotation of the sponge in a direction (V) opposite the direction (V1) in which it rotates when it machines the sanitaryware (2).

6. The method according to claim 1, wherein the rotation step is performed by independent drive means (7) located in the non-working area (6).

7. The method according to claim 1, wherein the rotation step is performed by power-driven means (7a) mounted on the unit (5).

8. The method according to claim 1, wherein the step of rotating the sponge (1) is performed simultaneously with the step of spraying liquid on the sponge (1).

9. The method according to claim 1, wherein the step of rotating the sponge (1) is performed before the step of spraying liquid.

10. The method according to claim 1, wherein the step of rotating the sponge (1) is stopped during the step of spraying liquid and resumed upon completion of the spraying step.

11. The method according to claim 1, wherein the step of squeezing the sponge (1) is performed simultaneously with the step of spraying liquid.

12. The method according to claim 1, wherein the step of squeezing the sponge (1) is performed after the step of spraying liquid.

13. The method according to claim 1, wherein the step of spraying liquid on the sponge (1) is performed in cycles repeated two or more times.

14. The method according to claim 1, wherein the step of squeezing the sponge (1) is performed in cycles repeated two or more times.

15. The method according to claim 1, wherein, between two successive steps of squeezing the sponge (1), there is a step of freely rotating the sponge (1) for a certain time at a predetermined speed so as to create a centrifugal force that causes the liquid to be expelled to move towards the outside surface of the sponge (1).

16. The method according to claim 1, wherein the step of rotating the sponge (1) is performed at a speed that varies in accordance with the subsequent spraying and squeezing steps.

17. The method according to claim 1, wherein the step of squeezing the pressure means (8) on the sponge (1) is performed by applying gradually increasing pressure on the sponge (1).

18. The method according to claim 1, wherein the step of squeezing the pressure means (8) on the sponge (1) is performed by applying a constant, instantaneous pressure on the sponge (1).

19. An apparatus for reconditioning a tool (1) made of porous material or sponge used to machine sanitaryware (2) or the like, especially ceramic sanitaryware (2), that undergoes a finishing process in a working area (3) of a production plant (4) equipped with a unit (5) for processing the sanitaryware (2), the apparatus comprising:
a non-working area (6) for reconditioning the sponge (1), which has the shape of a solid of revolution, said reconditioning area (6) being located in the vicinity of the working area (3);
means (7) for rotationally driving the sponge (1) about its axis (Z) of principal extension;
means (9) for spraying a cleaning or rinsing liquid on the sponge (1);
pressure means (8) acting on the sponge (1), rotatable about their axis, and movable relative to the sponge (1), towards and away from the sponge (1) along lines substantially transversal to the axis (Z) in such a way as to squeeze and thus clean the sponge (1).

20. The apparatus according to claim 19, wherein the drive means (7) are independent and located inside the reconditioning area (6); the drive means (7) comprising a power-driven shaft (10) that may be kinematically connected to a respective support (11) of the sponge (1) in such a way as to rotationally drive the sponge (1) in a direction of rotation (V).

21. The apparatus according to claim 19, wherein the drive means (7a) form an integral part of the unit (5) which is designed to be positioned inside the reconditioning area (6) and to subsequently rotate the sponge (1) in the direction of rotation (V).

22. The apparatus according to claim 19, wherein the reconditioning area (6) comprises an operating island, separate from the working area (3) and consisting of a sealed cabin (12).

23. The apparatus according to claim 19, wherein the reconditioning area (6) comprises an operating island, separate from the working area (3) and consisting of a sealed cabin (12) which houses the drive means (7), the spraying means (9) and the pressure means (8).

24. The apparatus according to claim 19, wherein the spraying means (9) comprise at least one adjustable nozzle (9a) connected to a source for supplying the liquid.

25. The apparatus according to claim 19, wherein the pressure means (8) comprise at least one pair of cylindrical rollers (13, 14) having a vertical axis (Z1) and being rotatable about said vertical axis (Z1); the pair of rollers (13, 14) being mounted on a frame (15) designed to position the rollers (13, 14) on opposite sides of the sponge (1) in use, the frame (15) being equipped with drive means (16) acting on the rollers (13, 14) in such a way as to move them from a position in which they are away from the sponge (1) to a position in which they are close to and squeeze the sponge (1) along a line transversal to the axis (Z) of the sponge (1).

26. The apparatus according to claim 19, wherein the pressure means (8) comprise at least two pairs of cylindrical rollers (13, 14; 17, 18) each having a vertical axis (Z1) and being rotatable about said vertical axis (Z1); said two pairs of rollers (13, 14; 17, 18) being mounted on a frame (15) designed to position each pair of rollers (13, 14; 17, 18) on opposite sides of the sponge (1) in use, the frame (15) being equipped with drive means (16) acting on the rollers (13, 14; 17, 18) in such a way as to move them from a position in which they are away from the sponge (1) to a position in which they are close to and squeeze the sponge (1) along a line transversal to the axis (Z) of the sponge (1).

27. The apparatus according to claim 25, wherein each roller (13, 14; 17, 18) is rotatable idly about its vertical axis (Z1).

28. The apparatus according to claim 25, wherein each roller (13, 14; 17, 18) has around its circumference a plurality of grooves (19) adapted to enable the liquid from the sponge (1) to be drained off when the roller (13, 14; 17, 18) itself is close to and squeezes the sponge (1).

29. The apparatus according to claim 25, wherein the drive means (16) are connected to the frame (15) and act on the rollers (13, 14; 17, 18) in such a way as to vary the pressure of contact with the sponge (1).

30. The apparatus according to claim 29, wherein the drive means (16) are independent of each other so that each of the rollers (13, 14; 17, 18) can exert a different pressure on the sponge (1).

31. The apparatus according to claim 28, wherein each of the rollers (13, 14; 17, 18) has a plurality of parallel circumferential grooves (19) located one after the other.

32. The apparatus according to claim 28, wherein each of the rollers (13, 14; 17, 18) has a single continuous circumferential groove (19a) extending along each roller (13, 14; 17, 18) to form a spiral around the roller (13, 14; 17, 18) itself.

33. The apparatus according to claim 19, wherein the means (7) for driving the sponge (1) move the sponge (1) in a direction (V) opposite to the working direction (V1) in which the sponge (1) rotates when machining.

34. The apparatus according to claim 26, wherein the frame (15) comprises two independent arms (15a, 15b), each mounting at one end of it a C-plate (20) associated with the respective arm (15a, 15b); there being, keyed to each plate (20) in freely rotatable manner, two bars, (21, 22), respectively upper and lower, for bilaterally supporting the pair of freely rotatable rollers (13, 14; 17, 18) placed side by side and rotating freely in such a way as to enable each pair of rollers (13, 14; 17, 18) to adapt to the contact with the outer surface of the sponge (1) when the rollers (13, 14; 17, 18) move close to and squeeze the sponge (1).

35. The apparatus according to claim 34, wherein each arm (15a, 15b) is kinematically linked at its other end to transmission means (23) controlled by the drive means (16) in such a way that the rollers (13, 14; 17, 18) move towards and squeeze the sponge (1) and then move away from the sponge (1).

36. The apparatus according to claim 35, wherein the transmission means (23) comprise a pair of meshing toothed wheels (23a, 23b); the shaft (23c, 23d) on which each wheel (23a, 23b) rotates being associated with a respective mounting arm (15a, 15b) in such way that the drive means (16) can move it along arc-shaped lines in a horizontal plane, opposite each other so as to cause the two pairs of rollers (13, 14; 17, 18) to simultaneously move towards and squeeze the sponge (1) and then move away from it.

37. The apparatus according to claim 36, wherein the drive means (16) comprise an actuator (16a) keyed by its stem (16b) to a plate attached to one of the toothed wheels, namely the drive wheel (23a), and at the opposite end, that is, on the cylinder (16c) of the actuator (16a), to a fixed support (24) in such a way that, as the stem (16b) moves backwards and forwards, the toothed wheels (23a, 23b) can rotate and thus move the arms (15a, 15b).

38. The apparatus according to claim 25, wherein each roller (13, 14; 17, 18) has an independent motor for rotationally driving it about its axis (Z1).

39. The apparatus according to claim 25, wherein each pair of rollers (13, 14; 17, 18) has an independent motor for rotationally driving the rollers (13, 14; 17, 18) about the axis (Z1).

40. The apparatus according to claim 36, wherein the actuator (16a) is controlled by a programmable control unit (30) that controls the pairs of rollers (13, 14; 17, 18) in such a way as to perform at least one sequence of automatic cycles in which the pairs of rollers (13, 14; 17, 18) move towards and squeeze the sponge (1) and then move away from it.

41. The apparatus according to claim 36, wherein the actuator (16a) is controlled by a programmable control unit (30) that controls the pairs of rollers (13, 14; 17, 18) in such a way as to enable them to move towards and squeeze the sponge (1) at least once with variable pressure.

42. The apparatus according to claim 36, wherein the actuator (16a) is controlled by a programmable control unit (30) that controls the pairs of rollers (13, 14; 17, 18) in such a way as to perform at least one sequence of automatic cycles in which the pairs of rollers (13, 14; 17, 18) move towards and squeeze the sponge and then move away from it and in which the pairs of rollers (13, 14; 17, 18) exert a variable pressure on the sponge (1) as they move towards and squeeze it.

43. The apparatus according to claim 36, wherein the actuator (16a) is of the pneumatic double-acting type controlled by the programmable control unit (30) that controls the movements of the pairs of rollers (13, 14; 17, 18); the unit (30) being connected to a duct (31) forming part of a circuit (32) for supplying a fluid to the actuator (16a) and acting directly on shutoff means (33) located on the duct (31) and designed to alternately feed fluid to the chambers (34, 35) of the actuator (16a), in such a way as to select the movement of the actuator (16a) corresponding to the movement of the pairs of rollers (13, 14; 17, 18) towards or away from the sponge (1).

44. The apparatus according to claim 43, wherein the programmable control unit (30) is also connected to and acts upon a pair of fluid flow regulators (34a, 35a) located at the intake end of the chambers (34, 35) of the actuator (16a) in order to vary the pressure exerted on the sponge (1) by the pairs of rollers (13, 14; 17, 18).

45. The apparatus according to claim 19, wherein the production plant (4) is equipped with an automated robotic unit (5) located in the vicinity of the working area (3) and designed to move the sponge (1) from the working area (3) to the non-working reconditioning area (6) which comprises an operating island that is separate from the working area (3) and houses at least the spraying means (9) and the pressure means (8).

46. The apparatus according to claim 19, wherein the automated robotic unit (5) itself constitutes the drive means (7) that moves the sponge (1) within the operating island.
